(19) United States
(12) Patent Application Publication
(10) Pub. No.: US 2005/0054375 A1
(43) Pub. Date: Mar. 10, 2005

(54) System and method for receiver management

(76) Inventors: Swetal A. Patel, Plantation, FL (US); Martin T. Karanja, Margate, FL (US); Philip A. Schentrup, Hollywood, FL (US)

Correspondence Address: Larry G. Brown;Motorola, Inc., Law Department, 8000 West Sunrise Boulevard, Fort Lauderdale, FL, 33322, US

(21) Appl. No.: 10/659,670

(22) Filed: Sep. 10, 2003

(51) Int. Cl. H04B 1/00; H04B 7/00; H04Q 7/20; H04M 1/00

(52) U.S. Cl. 455/552.1; 455/70; 455/517

(57) ABSTRACT

A method of managing a receiver. The method (300) includes the steps of selectively converting (326) a first communications channel (168) to a second communications channel (170), transmitting (328) data over the second communications channel (170) to a communications unit (128, 130) in which the data includes an information header (174) and reading (330) at least a portion of the information header (174) transmitted over the second communications channel (170). The method (300) can also include the step of selectively deactivating (332) a receiver (148, 158) of the communications unit (128, 130) in response to the reading step (330).

### CROSS REFERENCE TO RELATED APPLICATIONS

(Not Applicable)

### BACKGROUND

1. Technical Field

This invention relates in general to telecommunications systems and more particularly, to telecommunications systems that support dispatch service.

2. Description of the Related Art

Many mobile communications units support dual communication modes. In particular, a dual communication mode mobile unit can support both cellular telephone service (sometimes referred to as interconnect service) and trunked dispatch service. In the trunked dispatch service, a half-duplex channel is shared by all the participants of a dispatch call. During a dispatch call, the communications channel over which these participants speak selectively switches between a traffic channel (TCH) and a temporary control channel (TCCH).

For example, many dual communications mode mobile units include a push-to-talk (PTT) button. When a user wishes to speak to a party participating in the dispatch call, the user presses the PTT button, and his voice is carried over the TCH. When the user releases the PTT button, the TCH is converted to the TCCH for a predetermined amount of time or at least until another participant presses his PTT button to speak, whichever comes first. This temporal period, whether its duration is predetermined or is based on the subsequent initiation of a PTT button, is commonly referred to as a hang time. The hang time can have a maximum duration. For example, if no other participant presses their PTT button after a predetermined amount of time has lapsed, the TCCH and the TCH are terminated. This predetermined hang time can be as longs as six seconds. If another participant presses his PTT button to speak before the maximum duration of the hang time has lapsed, however, the TCCH is converted back to the TCH, and the participant's voice is carried over the TCH. In any event, during a dispatch call, the TCH is converted to the TCCH for at least a certain amount of time, sometimes as long as six seconds.

As can be gleaned from the above discussion, the TCCH is not intended to carry voice traffic. Nonetheless, while the TCH is converted to the TCCH, certain types of data can be transmitted to the mobile units that are part of a dispatch call. For example, a dispatch application processor, part of the fixed network equipment servicing dual communications mode mobile units, can signal the appropriate base station to transmit operations data, such as neighbor cell information including operating frequencies, to the mobile units over the TCCH. In particular, the neighbor cell information assists the mobile unit when it switches or reconnects from one cell to another.

Because data is being transmitted over the TCCH, the receiver of the dual communications mobile unit must remain on while the TCH is converted to the TCCH, i.e., during the hang time. Having the receiver on permits the mobile unit to process, for example, the incoming neighboring cell information. Notably, however, keeping the receiver on during the hang time, particularly if the hang time lasts for six seconds, can drain a significant amount of current and can lead to shorter battery life.

### SUMMARY OF THE INVENTION

The present invention concerns a method of managing a receiver. The method includes the steps of selectively converting a first communications channel to a second communications channel, transmitting data over the second communications channel to a communications unit in which the data includes an information header, reading at least a portion of the information header transmitted over the second communications channel and, in response to the reading step, selectively deactivating a receiver of the communications unit.

In one arrangement, the information header can include a channel indicator, and the selectively converting step can include the step of selectively converting the first communications channel to the second communications channel by setting the channel indicator to a predetermined value. The selectively deactivating step can further include selectively deactivating the receiver of the communications unit when the channel indicator is set to the predetermined value. In another arrangement, the information header can further include an override indicator, and the selectively deactivating step can further include selectively deactivating the receiver of the communications unit when the channel indicator is set to the predetermined value and when the override indicator indicates that no override condition exists.

In another embodiment, the method can further include the step of reactivating the receiver of the communications unit in response to a reactivating event. The selectively deactivating step can be performed in a first cell and the reactivating event can be the communications unit entering a second cell. Further, the information header can include a channel indicator, and the reactivating event is the channel indicator being set to a predetermined value to indicate that the second communications channel has been converted back to the first communications channel.

In yet another embodiment, the information header can include an override indicator, and the reactivating event can be the override indicator being set to a predetermined value that indicates that an override condition exists. As another example, the reactivating event can be a call being terminated.

The data can further include a payload section, and the method can also include the step of, following the selectively deactivating step, ignoring the payload section of the data. The payload section can also include operating information of at least one neighboring cell.

As an example, the first communications channel can be a traffic channel, and the second communications channel can be a temporary control channel. Both the traffic channel and the temporary control channel can be employed in a trunked dispatch service. As another example, the first communications channel and the second communications channel can employ time division multiple access as a transport mechanism, and the information header can be a slot descriptor block.

The present invention also concerns a system for managing a receiver. The system includes at least one base station and an application processor. The application processor can instruct the base station to convert the first communications channel to a second communications channel and to transmit data over the second communications channel to a communications unit having a receiver. The data includes an information header, and the communications unit reads at least a portion of the information header transmitted over the second communications channel and in response, selectively deactivates the receiver. The system can further include suitable software and circuitry for implementing the method described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a telecommunications system in accordance with the inventive arrangements.

FIG. 2 illustrates in greater detail the telecommunications system of FIG. 1 in accordance with the inventive arrangements.

FIG. 3 illustrates a method for notifying callers in accordance with the inventive arrangements.

FIG. 4 illustrates a group of cells that are part of the telecommunications system of FIGS. 1 and 2 in accordance with the inventive arrangements.

FIG. 5 illustrates several channels of a wireless communications link in accordance with the inventive arrangements.

FIG. 6 illustrates portions of an example of a time slot in accordance with the inventive arrangements.

FIG. 7 illustrates in greater detail a step of FIG. 3 in accordance with the inventive arrangements.

FIG. 8 illustrates in greater detail yet another step of FIG. 3 in accordance with the inventive arrangements.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

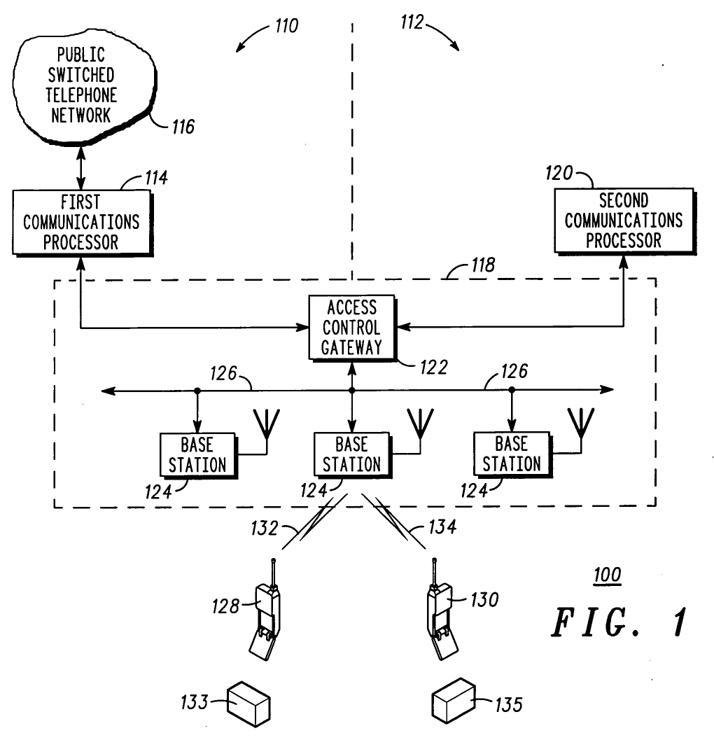

Referring to FIG. 1, a telecommunications system 100 is shown. As an example and without limitation, the system 100 can include both a cellular telephone services portion 110 for supporting cellular telephone services and a trunked dispatch services portion 112 for supporting trunked dispatch services. To support the cellular telephone services, the cellular telephone services portion 110 can include a first communications processor 114, which can be coupled to the public switched telephone network (PSTN) 116 and at least one site 118. The site 118 can include infrastructure that supports wireless communications.

To support the dispatch services, the dispatch services portion 112 can include a second communications processor 120, which can also be coupled to the site 118. As such, both the first communications processor 114 and the second communications processor 120 can share the infrastructure of the site 118 for processing both the cellular telephone and dispatch services. Although such a shared configuration is efficient, it is not necessary for the operation of either of these services. In addition, it is understood that the cellular telephone services portion 110 and the trunked dispatch services portion 112 can be coupled to sites other than or in addition to site 118.

In one arrangement, the site 118 can include one or more access control gateways 122, one or more base stations 124 and one or more buses 126 for coupling the base stations 124 to the access control gateway 122. The base stations 124 can communicate with, for example, a first communications unit 128 over a wireless communications link 132 and with, as another example, a second communications unit 130 over another wireless communications link 134. Continuing with the example, a first user 133 may operate the first communications unit 128, and a second user 135 may operate the second communications unit 130, and the first user 133 and the second user 135 may be engaged in a cellular telephone call or a dispatch call.

Of course, the invention is not limited to this particular example, as any suitable number of users or members using any suitable number of communications units is contemplated. Moreover, either of the first communications unit 128 or the second communications unit 130, depending on their location, may be serviced by another site. The first communications unit 128 and the second communications unit 130 may support both cellular telephone service and dispatch service, although the first communications unit 128 and the second communications unit 130 are not limited in this regard. In fact, the term “communications unit” can include any telecommunications unit suitable for conducting a call, including even a fixed telecommunications device.

The access control gateway 122 can include a computational platform having computational capacity and storage sufficient to support the functions described below. In addition, the link between the access control gateway 122 and the first communications processor 114 can be any high-level data link, as defined by the International Standards Organization. In one arrangement, the link between the access control gateway 122 and the second communications processor 120 can be a frame relay link. It is understood, however, that the invention is not limited in this regard, as any other suitable link can be used between the access control gateway 122 and the first communications processor 114 and second communications processor 120.

The base stations 124 can include radio transceivers configured to receive and transmit on appropriate frequencies using suitable modulation and air interface protocols for supporting the requirements of the services being provided. In another arrangement, the bus 126 that couples the base stations 124 to the access control gateway 122 can be an Ethernet link, as well understood in the art.

The operation and configuration of the cellular telephone services portion 110 is well known, and an in-depth discussion is not warranted. Briefly, however, the first communications processor 114 can include a mobile switching center (not shown), a telephone database (not shown) and a base site controller (not shown). As appreciated by those of skill in the art, the mobile switching center can interface with the PSTN 116 and the base site controller. The mobile switching center can also control the provision of cellular telephone service to, for example, the first communications unit 128 and the second communications unit 130, if the first communications unit 128 and the second communications unit 130 support such a service. The telephone database can be coupled to the mobile switching center and can provide to the mobile switching center information concerning the operation of communications units, such as the first communications unit 128 and the second communications unit 130.

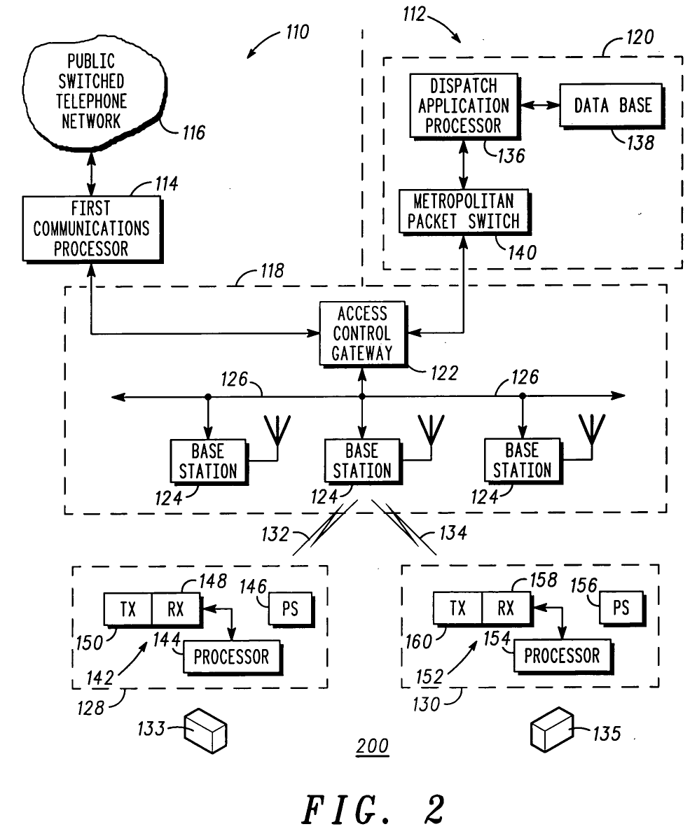

Referring to FIG. 2, the second communications processor 120 can include an application processor such as a dispatch application processor 136, a database 138 coupled to the dispatch application processor 136 and a metropolitan packet switch 140, which can also be coupled to the dispatch application processor 136. Further, the dispatch application processor 136 can be coupled to the access control gateway 122 through the metropolitan packet switch 140.

In one arrangement, the dispatch application processor 136 can be programmed to allocate communication resources among dispatch service users and can alert other users that a dispatch call is imminently or presently underway to enable those users to participate in the call. In accordance with the inventive arrangements, the dispatch application processor 136 may also signal the base station 124 to transmit data that can cause the selective deactivation of a receiver in a communications unit. This process will be explained later.

As those of ordinary skill in the art will appreciate, the metropolitan packet switch 140 can route audio signals between sites to facilitate the inclusion of other users that are located in other sites that the trunked dispatch services portion 112 serves. The database 138 can include information that relates to the operability status of, for example, the first communications unit 128 and the second communications unit 130, although the database 138 can include information relating to the operability status of any suitable number of communications units. As an example and without limitation, the information stored by the database 138 can include individual identification, group identification, alias information, roaming status and priority information.

The first communications unit 128 can include a transceiver 142, a processor 144 coupled to the transceiver 142 and a power supply 146. The transceiver 142 can include a receiver 148 for receiving signals over the wireless communications link 132 and a transmitter 150 for transmitting signals over the wireless communications link 132. The processor 144 can process, for example, the incoming signals received by the receiver 148 and can, in response to certain data contained in the signals, deactivate the receiver 148. Similarly, the second communications unit 130 can include a transceiver 152, a processor 154 coupled to the transceiver 152 and a power supply 156, and the transceiver 152 can include a receiver 158 and a transmitter 160. These components of the second communications unit 130 can operate in accordance with the discussion above relating to the first communications unit 128.

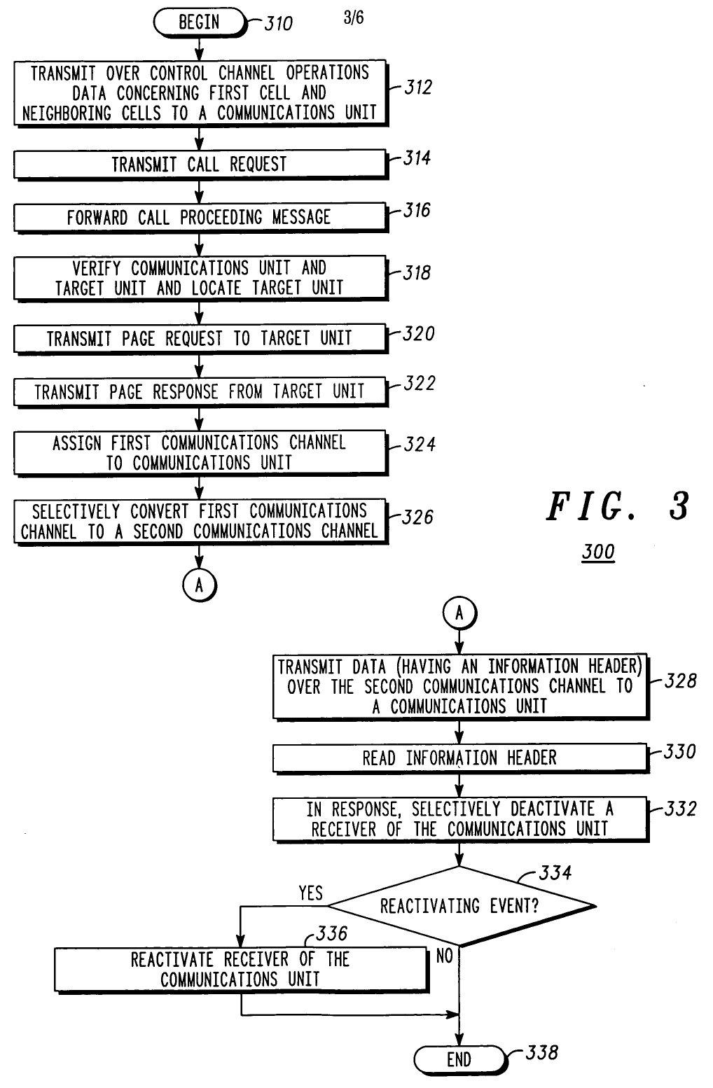

The overall operation of the dispatch services portion 112 of the system 100 in accordance with the inventive arrangements will now be described. Referring to FIG. 3, a method 300 for managing a receiver is shown. Reference will be continuously made to FIG. 2 and FIGS. 4-6, each of which will be described later, as the steps of method 300 are explained. It is understood, however, that the method 300 is in no way limited to being practiced in the system 100 of FIG. 2, as the method 300 can be implemented into any other suitable communications system.

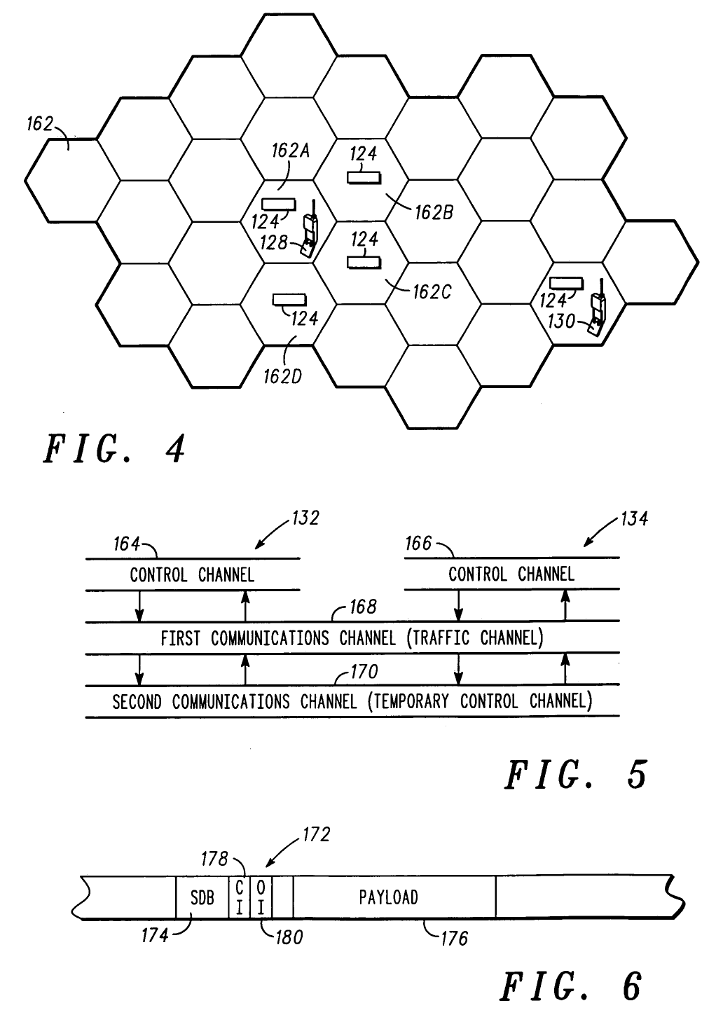

At step 310, the method 300 can begin. At step 312, operations data concerning a first cell and neighboring cells can be transmitted to a communications unit over a control channel, such as a broadcast control channel. Referring to FIGS. 4 and 5, an example of this process will be explained. In FIG. 4, a group of cells 162 is shown. These cells 162 can be part of, for example, the dispatch services portion 112 of FIGS. 1 and 2. As is known in the art, each of the cells 162 can include a base station 124 (shown only in a portion of the cells 162) and can operate in frequencies that differ from those of neighboring cells 162. When a communications unit is in a particular cell 162, operations data about that cell 162 and neighboring cells 162 can be transmitted from the base station 124 to the communications unit.

As an example and without limitation, if the first communications unit 128 is located in a first cell 162A, the base station 124 in the cell 162A can transmit data about the cell 162A to the first communications unit 128 over a control channel 164 (see FIG. 5). The control channel 164 can be part of the wireless communications link 132. The transmitted data can include, for example, the operating frequencies of the cell 162A. Those of ordinary skill in the art will appreciate that other forms of data concerning the cell 162A, such as cell dispatch reconnection parameters, a protocol discriminator, a transaction identifier and a station identification, may be transmitted over the control channel 164 as well.

The base station 124 in the cell 162A can also transmit to the first communications unit 128 operations data concerning one or more neighboring cells 162, such as cell 162B, cell 162C and cell 162D (only a portion of the possible neighboring cells is listed here). This data, for example, can include the operating frequencies of the cells 162B, 162C and 162D and can also be transmitted over the control channel 164 (as is known in the art, this data can include other suitable forms of information concerning any neighboring cells).

Transmitting this information to the first communications unit 128 can assist the first communications unit 128 as it moves from the first cell 162A to, for example, any of the neighboring cells 162B, 162C or 162D. As is known in the art, as the first communications unit 128 moves from the first cell 162A to one of the neighboring cells 162B, 162C or 162D, the first communications unit 128 may reconnect with the base station 124 located in the particular neighboring cell (cell 162B, cell 162C or cell 162D) into which it has traveled. Once in the new cell 162, the base station 124 in the new cell 162 will transmit over the control channel 164 data concerning the new cell 162 and one or more of its neighboring cells 162. A similar process can occur for the second communications unit 130 or any other suitable communications unit.

Referring back to FIG. 3, at step 314 a user can cause a call request, such as a dispatch call request, to be transmitted from a communication unit. For example, the first user 133 can cause a dispatch call request to be sent from the first communication unit 128. This call request can travel over the control channel 164 to one of the base stations 124. The base station 124 can transmit the call request to the access control gateway 122, which can forward the call request to the dispatch application processor 136.

During this process, a call proceeding message can be forwarded to the communications unit, as shown at step 316. For example, the access control gateway 122 can transmit through the base station 124 a message to the first communications unit 128 notifying the first user 133 that the call is proceeding. This message can also be transmitted over the control channel 164 of the wireless communications link 132. Subsequently, at step 318, it can be verified that the communications unit that initiated the call request and the communications unit that it is trying to contact, i.e., the target communications unit or target unit, are authorized units. Also, in this step, the target communications unit can be located.

As an example, when the dispatch application processor 136 receives the call request, the dispatch application processor 136 can access the database 138. In this example, the target communications unit can be the second communications unit 130, which can be located in any cell 162 (see FIG. 4). By accessing the database 138, the dispatch application processor 136 can verify that the first communications unit 128 and the second communication unit 130 are authorized units and can determine the particular cell 162 in which the second communications unit 130 is located.

At step 320, a page request can be transmitted to the target communications unit. Continuing with the example, the dispatch application processor 136 can generate the page request, which can be sent to the access control gateway 122, the base station 124 and on to the second communications unit 130 over the wireless communications link 134. Specifically, the page request can be transmitted over a control channel 166 of the wireless communications link 134 (see FIG. 5). It is understood that the target communications unit may be located in an area that is not being serviced by the site that is currently servicing the initiating communications unit. As an example, the second communications unit 130 may be located in an area that is serviced by another site (different from the site 118).

At step 322, in response to the page request, a page response can be transmitted from the target communications unit. For example, the second communications unit 130 can send a page response over the control channel 166 of the wireless communications link 134 to the base station 124. The base station 124 can then forward the page response to the access control gateway 122, which can transmit the signal to the dispatch application processor 136.

Once the page response is received, at step 324, a first communications channel can be assigned to the communications units (the unit that initiated the call and the target unit). For example, when the dispatch application processor 136 receives the page response from the second communications unit 130, the dispatch application processor 136 can assign a first communications channel 168 (see FIG. 5) over which the first communications unit 128 and the second communications unit 130 can communicate. The first communications channel 168 can also be part of the wireless communications link 132 and the wireless communications link 134. In one arrangement, this first communications channel 168 can be a traffic channel (TCH), a channel that is commonly used to carry dispatch communications traffic between communications units that support such a service.

As the communications unit that initiated the call and the target communications unit communicate with one another, the first communications channel 168 may eventually be converted, at least temporarily, to a second communications channel 170 (see FIG. 5). Specifically, the first communications channel 168 can be selectively converted to the second communications channel 170, as shown in step 326. The second communications channel 170 can also be part of the wireless communications link 132 and the wireless communications link 134. This conversion can occur when the first communications channel 168 is released. For purposes of the invention, the first communications channel 168 can be released when no communications units that are currently assigned to the first communications channel 168 are transmitting over the first communications channel 168.

As an example, the first communications unit 128 and the second communications unit 130 can support dispatch service. Both the first communications unit 128 and the second communications unit 130 can include an initiator (not shown), such as a push-to-talk (PTT) button, for initiating a transmission over the first communications channel 168. For example, when the first user 133 of the first communications unit 128 presses the PTT button, the first communications unit 128 can begin transmitting over the first communications channel 168 and the first user 133 can speak over the channel 168.

When the first user 133 releases the PTT button, the first communications unit 128 can transmit an end-of-transmission (EOT) message over the first communications channel 168 to the base station 124. At this point, the first communications unit 128 is no longer transmitting over the first communications channel 168, and the channel 168 is released. The base station 124 can relay the EOT message to the dispatch application processor 136 through the access control gateway 122. In response, the dispatch application processor 136 can instruct the base station 124 (through the access control gateway 122) to convert, at least temporarily, the first communications channel 168 to the second communications channel 170. As an example, the second communications channel 170 can be a temporary control channel (TCCH). Referring back to the method 300, at step 328 (through jump circle A), certain data, which can include at least an information header (to be described below), can be transmitted over the second communications channel 170 to a communications unit.

In one arrangement, the transport mechanism used to carry signals in the system 100 can be time division multiple access (TDMA). Of course, any other suitable transport mechanism can be used with the invention. As is known in the art, a TDMA communications channel can be divided into time slots, an example of which is shown in FIG. 6. Here, a slot 172 can include an information header 174, which can be, for example, a slot descriptor block (SDB). The slot 172 can also include a payload section 176.

As an example, the information header 174 can be a five byte parameter that can include a channel indicator 178 and an override indicator 180. The channel indicator 178 can be one or more bits that can be set to a predetermined value to identify the type of channel over which the slot 172 is currently being carried. For example, the channel indicator 178 can identify whether the channel carrying the slot 172 is one of the control channels 164, 166, the first communications channel 168 or the second communications channel 170. Additionally, the override indicator 180 can be one or more bits that can be set to a predetermined value to indicate whether data contained in the payload section 176 should be processed or ignored. This indication can be referred to as an override condition.

In one arrangement, the payload section 176 can be an eleven byte parameter that can contain many different types of data. As an example, if the slot 172 is being carried over the first communications channel 168, e.g., the TCH, the payload section 176 can carry voice traffic data. Alternatively, if the slot 172 is being carried over the second communications channel 170, e.g., the TCCH, the payload section 176 can carry operations data concerning a particular cell 162 and its neighboring cells 162. This operations data can be the data that was previously described with respect to step 312, such as the operating parameters of a particular cell 162 and its neighboring cells 162. Thus, as an example, the base station 124 can transmit operations data to the first communications unit 128 over the control channel 164 and the second communications channel 170.

To convert the first communications channel 168 to the second communications channel 170, the channel indicator 178 can be set to a predetermined value. For example, when the dispatch application processor 136 receives the EOT message (see discussion above), the dispatch application processor 136 can signal the appropriate base station 124 (through the access control gateway 122). In response, the base station 124 can set the channel indicator 178 in the slot 172 to indicate that the channel over which the slot 172 is being carried is now the second communications channel 170.

Referring back to the method 300, at step 330, at least a portion of the information header 174 that has been transmitted over the second communications channel 170 can be read. As an example, when the receiver 148 of the first communications unit 128 receives the slot 172, the processor 144 can read the information header 174 and can determine that the slot 172 is being received over the second communications channel 170. At step 332, in response to the reading step 330, a receiver of a communications unit can be selectively deactivated. For example, once it has read the information header 174, the processor 144 can selectively shut down the receiver 148 of the first communications unit 128. Shutting down a receiver in this fashion can prolong the life of a battery that is supplying power to a communications unit.

There are several events that may trigger the deactivation of the receiver of a particular communications unit. For example, converting the first communications channel 168 to the second communications channel 170 can trigger the deactivation of the receiver of a communications unit. As another example, an override condition, or a particular value of the override indicator 180, can cause the receiver to be deactivated. Either one of these examples individually or in combination with each other can trigger the deactivation process.

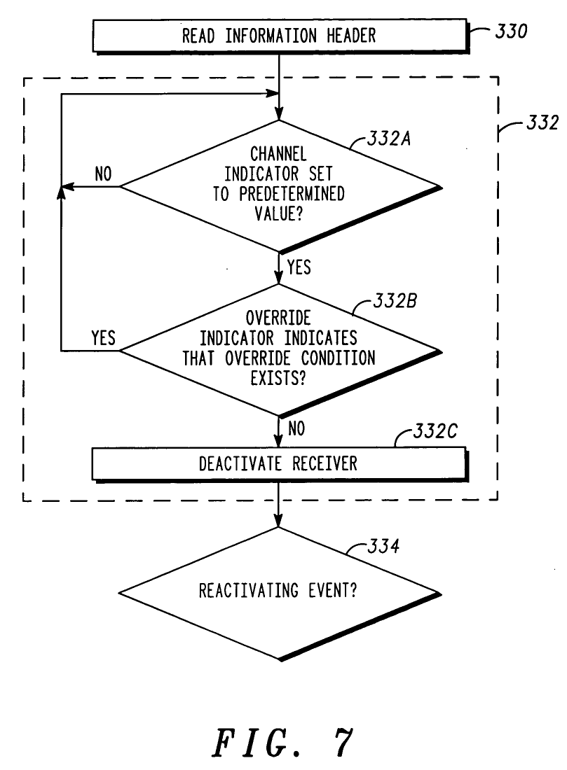

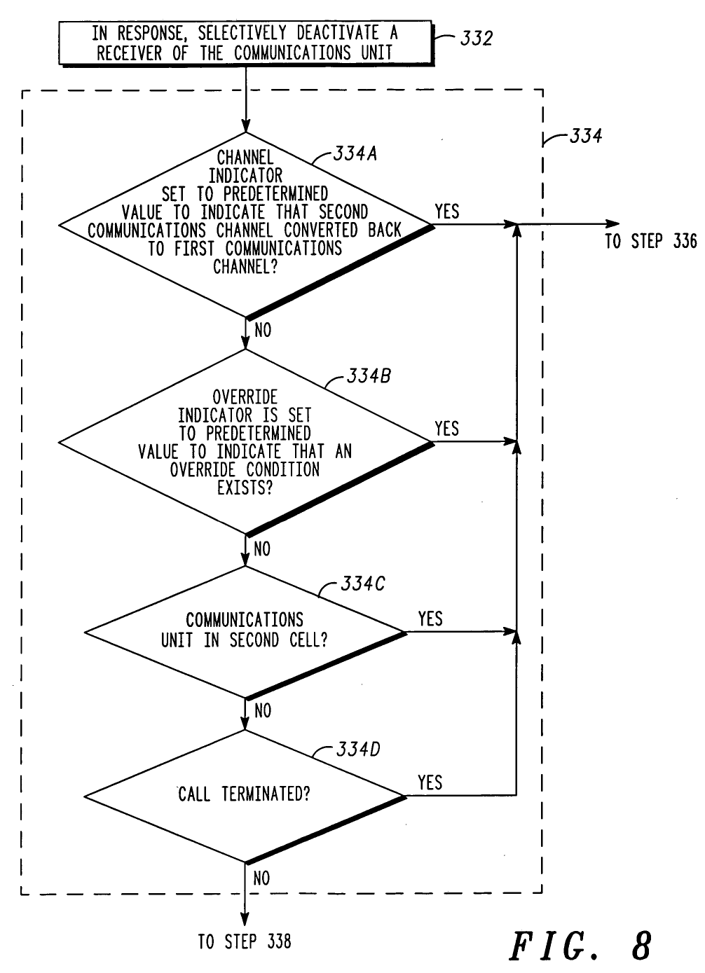

To illustrate these examples, step 332 of the method 300 is shown in FIG. 7 as being comprised of several other steps (FIG. 7 shows only a portion of the method 300). In one arrangement, step 332 can include a decision block 332A, a decision block 332B and a step 332C. At decision block 332A, it can be determined whether the channel indicator 178 has been set to a predetermined value that indicates that the first communications channel 168 has been converted to the second communications channel 170. If it has, at decision block 332B, it can be determined whether the override indicator 180 has been set to a predetermined value to indicate that an override condition exists. If it does not, the receiver of the communications unit can be deactivated at step 332C.

For example, the base station 124, after receiving instructions from the dispatch application processor 136, can set the value of the channel indicator 178 in the information header 174 of the slot 172 to indicate that the slot 172 is being transmitted over the second communications channel 170. In addition, the base station 124 can set the override indicator 180 to indicate that an override condition exists (set the override indicator 180 to a value that indicates that the data in the payload section 176 can be ignored). When, for example, the first communications unit 128 receives the slot 172, the processor 144 can deactivate the receiver 148 in response to these settings. Deactivating the receiver 148 can reduce the current drain from the power supply 146, thereby prolonging its life. A similar process can be performed for the second communications unit 130 or any other suitable communications unit.

In this example, by turning the receiver 148 off, the data in the payload section 176 can be ignored. As mentioned earlier, when the first communications channel 168 is converted to the second communications channel 170, operations data about the cell 162 in which a particular communications unit is located and several neighboring cells 162 can be transmitted over the second communications channel 170 to that communications unit. Because the communications unit has more than likely already received this information previously over a control channel, however, this operations data becomes redundant. As a result, it can be ignored, and by doing so, the operation of the communications unit is not adversely affected.

The resultant savings in current drain can be significant. Notably, the payload section 176 of a slot 172 contains most of the data carried in the slot 172. Accordingly, the receiver is activated for a longer period of time when it is receiving the payload section 176 as compared to the amount of time spent receiving the information header 174. This increase in efficiency becomes particularly apparent if the receiver is receiving a large number of slots 172 over the second communications channel 170.

It is understood, however, that the invention is not limited to the above arrangement. Specifically, any other suitable event can be used to trigger the deactivation of the receiver of a communications unit when the receiver is receiving data over the second communications channel 170 or any other channel. Moreover, it is unnecessary to have both the channel indicator 178 and the override indicator 180 set to a predetermined value to trigger the receiver shutdown. That is, either the channel indicator 178 or the override indicator 180 alone can be set to cause the receiver to be deactivated.

Referring back to the method 300, at decision block 334, it can be determined whether a reactivating event has occurred. If no reactivating event has occurred, the method 300 can end at step 338. If a reactivating event has occurred, the receiver of the communications unit can be reactivated at step 336, and the method 300 can end at step 338. The receiver of the communications unit may subsequently be deactivated again in accordance with the above discussion.

A reactivating event can be any event that may prompt the receiver of the communications unit to be turned on again. There are several reactivating events that may cause the receiver of the communications unit to be reactivated, and referring to FIG. 8, the decision block 334 has been expanded to show four examples. The decision block 334 can include a decision block 334A, a decision block 334B, a decision block 334C and a decision block 334D. At decision block 334A, it can be determined whether the channel indicator 178 has been set to a predetermined value that indicates that the second communications channel 170 has been converted back to the first communications channel 168. If it has, the method 300 can continue at step 336, where the receiver of the communications unit can be reactivated.

Consider this example: the first communications unit 128 and the second communications unit 130 are engaged in a call, and the first user 133 has just released the PTT button on the first communications unit 128. As described earlier, the channel indicator 178 can be set to a predetermined value to indicate that the first communications channel 168 has been converted to the second communications channel 170 (at this point, the receiver 148 of the first communications unit 128, as well as the receiver 158 of the second communications unit 130, can be deactivated (see step 332).

Subsequently, the second user 135 can press the PTT button of the second communications unit 130, and the second communications unit 130 can transmit an update request (UR) message over the second communications channel 170. The base station 124 can receive the UR message and can forward it to the dispatch application processor 136 (through the access control gateway 122).

In response, the dispatch application processor 136 can signal the base station 124 (also through the access control gateway 122) to convert the second communications channel 170, e.g., the TCCH, back to the first communications channel 168, e.g., the TCH. The conversion is carried out similar to the process described above in which the base station 124 can set the channel indicator 178 to a predetermined value to indicate that the channel over which the current slot 172 is being received is the first communications channel 168. As a result, the processor 144 of the first communications unit 128 and the processor 154 of the second communications unit 130 can respectively reactivate the receiver 148 and the receiver 158. This operation can permit the receivers 148, 158 to receive data over the first communications channel 168, which is typically voice traffic.

Referring back to FIG. 8, if the second communications channel 170 has not been converted back to the first communications channel 168, at decision block 334B, it can be determined whether the override indicator 180 has been set to a predetermined value to indicate that an override condition exists. If an override condition exists, the method 300 can continue at step 336, and the receiver of the communications unit can be reactivated. Consider this example: the first communications unit 128 and the second communications unit 130 are engaged in a call and the slot 172 is being transmitted over the second communications channel 170. The receivers 148, 158 can be currently deactivated.

In certain circumstances, it may be desirable to transmit a message to one of or both the first user 133 and the second user 135 over the second communications channel 170. For example, a third party using another communications unit may wish to let either the first user 133 or the second user 135 (or both) know that the third party is trying to reach one or both of them. The dispatch application processor 136 can generate such a message, and can instruct the base station 124 to transmit it over the second communications channel 170. This message can be carried in the payload sections 176 of the slots 172.

To reactivate the receivers 148, 158, the dispatch application processor 136 can also instruct the base station 124 to set the override indicator 180 to a predetermined value to indicate that an override condition exists. Once the processors 144, 154 recognize the override condition, the processors 144, 154 can reactivate the appropriate receivers 148, 158, which can enable the receivers 148, 158 to receive the message over the second communications channel 170.

Referring once again to FIG. 8, at decision block 334C, it can be determined whether the communications unit has entered a new or second cell. If it has, the method 300 can continue at step 336, where the receiver of the communications unit can be reactivated. Consider this example: the first communications unit 128 and the second communications unit 130 are engaged in a call, and the slots 172 are being carried over the second communications channel 170. Thus, the receivers 148, 158 may be turned off. If the first communication unit 128 moves from a first cell 162 into the transmission area of a second cell 162, i.e., it reconnects with a second cell, it may be necessary to provide the first communications unit 128 with new operations data. This operations data can be associated with the second cell 162 and the neighboring cells 162 of the second cell 162, and is similar to the operations data described above in relation to step 312. As also explained earlier, the operations data can be carried in the payload section 176 of the slots 172 that are being transmitted over the second communications channel 170.

When the first communications unit 128 reconnects with the new or second cell 162, a process that is well known in the art, the processor 144 of the first communications unit 128 can reactivate the receiver 148. The reactivation step can allow the first communications unit 128 to receive the operations data about the second cell 162 and the neighboring cells 162 of the second cell 162.

Referring back to FIG. 8, at decision block 334D, it can be determined whether the call has been terminated. If yes, the method 300 can resume at step 336, and the receiver of the communications unit can be switched back on. If the call has not been terminated, then no reactivating events have occurred, and the method 300 can end at step 338.

As an example, the first communications unit 128 and the second communications unit 130 can be engaged in a call, and the slots 172 can currently be transmitted over the second communications channel 170. If neither the first communications unit 128 nor the second communications 130 responds after a predetermined hang time has elapsed, the dispatch application processor 136 can signal the base station 124 to terminate the first communications channel 168 and the second communications channel 170. In response, the processors 144, 154 can reactivate their respective receivers 148, 158. Subsequently, the first communications unit 128 and the second communications unit 130 can receive operations data over their respective control channels 164, 166. This operations data is associated with the cell(s) 162 in which the first communications unit 128 and the second communications unit 130 reside and the neighboring cells 162. It is also like the operations data described in relation to step 312 and can be transmitted in a similar fashion. It must be noted that the invention is not limited to the above examples of reactivating events. That is, other events can be used to reactivate a receiver of a communications unit once the receiver has been deactivated.

While the first communications unit 128 and the second communications unit 130 were used for purposes of explaining the operation of the invention, it is understood that the invention is in no way limited to these particular devices. That is, any suitable number and type of communications units can be practiced with the invention. Moreover, the invention is not limited to being implemented into system 100, as the invention can be incorporated into any other suitable communications system.

In addition, while the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method of managing a receiver, comprising the steps of:
selectively converting a first communications channel to a second communications channel;
transmitting data over the second communications channel to a communications unit, wherein the data includes an information header;
reading at least a portion of the information header transmitted over the second communications channel; and
in response to said reading step, selectively deactivating a receiver of the communications unit.

2. The method according to claim 1, wherein the information header includes a channel indicator and said selectively converting step comprises the step of selectively converting the first communications channel to the second communications channel by setting the channel indicator to a predetermined value.

3. The method according to claim 2, wherein said selectively deactivating step further comprises selectively deactivating the receiver of the communications unit when the channel indicator is set to the predetermined value.

4. The method according to claim 3, wherein the information header further includes an override indicator and said selectively deactivating step further comprises selectively deactivating the receiver of the communications unit when the channel indicator is set to the predetermined value and when the override indicator indicates that no override condition exists.

5. The method according to claim 1, further comprising the step of reactivating the receiver of the communications unit in response to a reactivating event.

6. The method according to claim 5, wherein said selectively deactivating step is performed in a first cell and wherein the reactivating event is the communications unit entering a second cell.

7. The method according to claim 5, wherein the information header includes a channel indicator and wherein the reactivating event is the channel indicator being set to a predetermined value to indicate that the second communications channel has been converted back to the first communications channel.

8. The method according to claim 5, wherein the information header includes an override indicator and the reactivating event is the override indicator being set to a predetermined value that indicates that an override condition exists.

9. The method according to claim 5, wherein the reactivating event is a call being terminated.

10. The method according to claim 1, wherein the data further includes a payload section and said method further comprises the step of, following said selectively deactivating step, ignoring the payload section of the data.

11. The method according to claim 10, wherein the payload section includes operating information of at least one neighboring cell.

12. The method according to claim 1, wherein the first communications channel is a traffic channel and the second communications channel is a temporary control channel, both the traffic channel and the temporary control channel being employed in a trunked dispatch service.

13. The method according to claim 1, wherein the first communications channel and the second communications channel employ time division multiple access as a transport mechanism and wherein the information header is a slot descriptor block.

14. A system for managing a receiver, comprising:
at least one base station; and
an application processor, wherein said application processor instructs said base station to convert the first communications channel to a second communications channel and to transmit data over the second communications channel to a communications unit having a receiver, wherein the data includes an information header;
wherein the communications unit reads at least a portion of the information header transmitted over the second communications channel and in response, selectively deactivates the receiver.

15. The system according to claim 14, wherein the information header includes a channel indicator and said application processor further instructs said base station to convert the first communications channel to the second communications channel by setting the channel indicator to a predetermined value.

16. The system according to claim 15, wherein the communications unit selectively deactivates the receiver when the channel indicator is set to the predetermined value.

17. The system according to claim 16, wherein the information header further includes an override indicator and wherein the communications unit selectively deactivates the receiver when the channel indicator is set to the predetermined value and when the override indicator indicates that no override condition exists.

18. The system according to claim 14, wherein the communications unit reactivates the receiver in response to a reactivating event.

19. The system according to 18, wherein the communications unit selectively deactivates the receiver in a first cell and wherein the reactivating event is the communications unit entering a second cell.

20. The system according to claim 18, wherein the information header includes a channel indicator and wherein the reactivating event is when said base station sets the channel indicator to a predetermined value to indicate that the second communications channel has been converted back to the first communications channel.

21. The system according to claim 18, wherein the information header includes an override indicator and the reactivating event is said base station setting the override indicator to a predetermined value that indicates that an override condition exists.

22. The system according to claim 18, wherein the reactivating event is said base station terminating a call on said system.
